(19) United States
(12) Patent Application Publication
(10) Pub. No.: US 2026/0044945 A1
(43) Pub. Date: Feb. 12, 2026

(54) METHOD AND APPARATUS FOR DETERMINING IMAGE NORMALITY USING AN ARTIFICIAL INTELLIGENCE MODEL

(71) Applicant: ELECTRONICS AND TELECOMMUNICATIONS RESEARCH INSTITUTE, Daejeon (KR)

(72) Inventors: Yong Je CHOI, Daejeon (KR); Bum Suk CHOI, Daejeon (KR); Sang Su LEE, Daejeon (KR); Dae Won KIM, Daejeon (KR); Dong Ho KANG, Daejeon (KR); Jeong Nyeo KIM, Daejeon (KR)

(73) Assignee: ELECTRONICS AND TELECOMMUNICATIONS RESEARCH INSTITUTE, Daejeon (KR)

(21) Appl. No.: 19/212,859

(22) Filed: May 20, 2025

(30) Foreign Application Priority Data
Aug. 6, 2024 (KR) 10-2024-0104782

(51) Int. Cl. G06T 7/00

(52) U.S. Cl. CPC G06T 7/0004; G06T 2207/20072; G06T 2207/20081; G06T 2207/30141

(57) ABSTRACT

A method and apparatus determine image normality using an artificial intelligence model. A method for determining image normality using an anomaly detection model includes obtaining an inference result of the anomaly detection model. The method further includes determining a step size and a size of an inspection window for identifying abnormal regions. The method also includes calculating an AUROC value based on the inspection window. The method further includes determining whether a region of the inspection window is normal or abnormal by comparing the AUROC value with a predefined threshold. The method also includes determining whether an image is normal or abnormal based on the result of identifying abnormal regions.

### CROSS-REFERENCE TO RELATED APPLICATION

The present application claims priority to Korean Patent Application No. 10-2024-0104782, filed on Aug. 6, 2024 in the Korea Intellectual Property Office, the entire contents of which are incorporated herein by reference.

### TECHNICAL FIELD

The present disclosure relates to a method and an apparatus for determining image normality using an artificial intelligence model. More specifically, the present disclosure relates to a method and an apparatus for determining image normality by analyzing an inference result of an artificial intelligence model.

### BACKGROUND

The statements in this section merely provide background information related to the present disclosure and do not necessarily constitute prior art.

Unsupervised learning is a type of machine learning and is a method of learning patterns or structures for input data without a predefined label or a target value. Unsupervised learning may be used for understanding the structure of data, clustering data, or detecting anomalies.

An abnormal region detection technology using unsupervised learning may detect an abnormal region after training an artificial intelligence model using only normal data. Since the abnormal region detection technology using unsupervised learning enables learning of the artificial intelligence model without abnormal data, it may be used in an industrial field with little abnormal data.

The artificial intelligence model uses normalization to accurately analyze and predict data. The normalization is a process of standardizing the range and distribution of data to help the model learn more consistently and efficiently. Specifically, the normalization adjusts the range of pixel values in an image or standardizes the pixel values using a mean and a standard deviation. However, due to the normalization, minute changes may be overemphasized, or original features may be distorted. This may cause a normal image that does not actually differ from an original image to be recognized as abnormal.

### SUMMARY

An object of the present disclosure is to provide a method and an apparatus for determining image normality by analyzing abnormal data that is erroneously determined due to normalization.

A object of the present disclosure is to provide a method and an apparatus for determining image normality by dividing and analyzing an inference result of an artificial intelligence model into small regions.

The technical objects of the present disclosure are not limited to those described above, and other technical objects not mentioned above may be understood clearly by those skilled in the art from the descriptions given below.

An embodiment of the present disclosure provides a method for determining image normality using an anomaly detection model, the method comprising: obtaining an inference result of the anomaly detection model; determining a step size and a size of an inspection window for identifying abnormal regions; calculating an AUROC value based on the inspection window; determining whether a region of the inspection window is normal or abnormal by comparing the AUROC value with a predefined threshold; and determining whether an image is normal or abnormal based on the result of identifying abnormal regions.

Another embodiment of the present disclosure provides an apparatus for determining image normality using an anomaly detection model, the apparatus comprising: at least one memory storing instructions; and at least one processor, wherein the apparatus is configured to: obtain an inference result of the anomaly detection model; determine a step size and a size of an inspection window for identifying abnormal regions; calculate an AUROC value based on the inspection window; determine whether a region of the inspection window is normal or abnormal by comparing the AUROC value with a predefined threshold; and determine whether an image is normal or abnormal based on the result of identifying abnormal regions.

According to one embodiment of the present disclosure, by analyzing abnormal data that is erroneously determined due to normalization, a normal image that does not actually differ from an original image may not be recognized as abnormal.

According to one embodiment of the present disclosure, by dividing and analyzing the inference result of the artificial intelligence model into small regions, the location of an abnormal region of a printed circuit board (PCB) may be confirmed to determine image normality.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a schematic block diagram of an apparatus for determining image normality according to an embodiment of the present disclosure.

FIG. 2 is a conceptual diagram illustrating a learning process of an anomaly detection model according to an embodiment of the present disclosure.

FIG. 3 is a flowchart illustrating a learning process of an anomaly detection model according to an embodiment of the present disclosure.

FIG. 4 is an exemplary diagram illustrating an inference result with an abnormal region according to an embodiment of the present disclosure.

FIG. 5 is an exemplary diagram illustrating an inference result without an abnormal region according to an embodiment of the present disclosure.

FIG. 6 is a flowchart illustrating a process of determining image normality according to an embodiment of the present disclosure.

FIG. 7 is a flowchart illustrating a process of determining an abnormal region using a sliding AUROC according to an embodiment of the present disclosure.

FIG. 8 is a schematic block diagram of a computing apparatus that can be used to implement the method or the apparatus according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

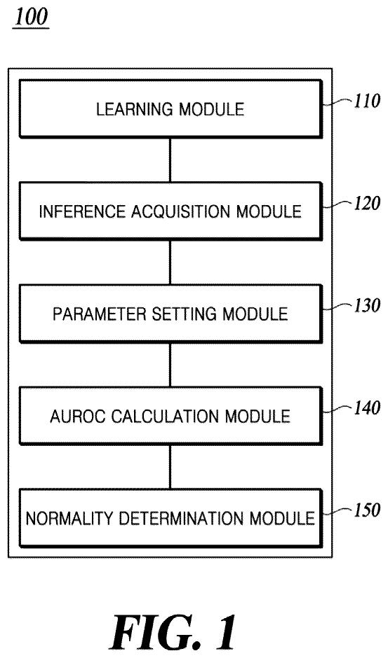

FIG. 1 is a schematic block diagram of an apparatus for determining image normality according to an embodiment of the present disclosure.

The apparatus for determining image normality 100 may include all or some of a learning module 110, an acquisition module 120, a parameter setting module 130, a calculation module 140, and a determination module 150. All blocks shown in FIG. 1 are not essential components, and some blocks included in the apparatus for determining image normality 100 may be added, changed, or deleted in other embodiments. On the other hand, components shown in FIG. 1 represent functionally distinct functional elements, and at least one component may be integrated with each other in an actual physical environment.

The learning module 110 may generate a normal learning dataset and an abnormal learning dataset using an original dataset. The learning module 110 may perform image data augmentation using the original dataset. The learning module 110 may train an anomaly detection model 200 to determine an abnormal region.

The acquisition module 120 may obtain a result of determining the abnormal region using the trained anomaly detection model 200. In particular, the trained anomaly detection model 200 may output a heatmap image as an inference result.

The parameter setting module 130 may be configured to set one or more parameters related to an inspection window, such as a window size and a step size, in an embodiment. The size of the inspection window and the step size may be set differently depending on the characteristics of an image and the purpose of analysis.

The calculation module 140 may extract a data value of the heatmap image based on the size of the inspection window and calculate an area under the receiver operating characteristic curve (AUROC) value. The calculation module 140 may calculate the AUROC value using heatmap values within the inspection window each time the inspection window moves.

The determination module 150 may compare the calculated AUROC value with a predefined threshold to determine whether the region of the inspection window is normal or abnormal. In the present disclosure, a sliding AUROC method is used to determine whether a printed circuit board (PCB) image is normal. The sliding AUROC method refers to a technique in which a specific region of an image is set as an inspection window, the inspection window is gradually moved, and an AUROC value is calculated for each region.

The determination module 150 may store the determination result and output whether the image is normal.

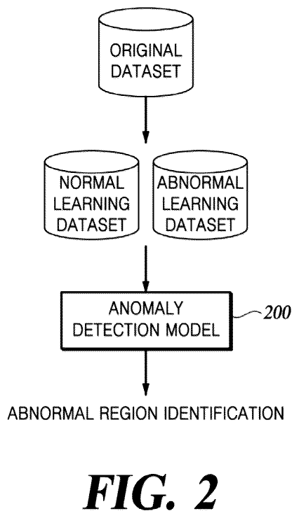

FIG. 2 is a conceptual diagram illustrating a learning process of an anomaly detection model according to an embodiment of the present disclosure.

The apparatus for determining image normality 100 may generate a normal learning dataset and an abnormal learning dataset using an original dataset. The apparatus for determining image normality 100 may perform image data augmentation using the original dataset.

The anomaly detection model 200, according to an embodiment of the present disclosure, may be trained to identify abnormal regions by receiving normal learning data sets and abnormal learning data sets. As an example, unsupervised learning may be used to train the anomaly detection model 200.

Unsupervised learning is a type of machine learning in which patterns or structures are learned from input data without predefined labels or target values. Unsupervised learning may be used for understanding the data structure, clustering, or anomaly detection.

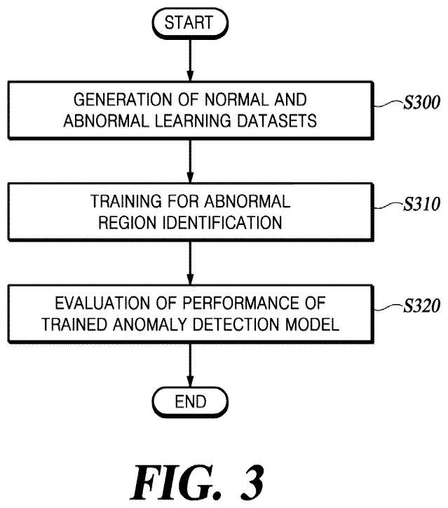

FIG. 3 is a flowchart illustrating a learning process of an anomaly detection model according to an embodiment of the present disclosure.

The apparatus for determining image normality 100 may generate a normal learning dataset and an abnormal learning dataset using an original dataset (S300). The apparatus for determining image normality 100 may perform image data augmentation using the original dataset. The image data augmentation refers to transforming an original image into a new image. The image data augmentation may include operations such as rotation, translation, scaling, flipping, color jittering, and adding noise. The original dataset includes an original PCB image. The normal learning dataset may include an image dataset obtained through translation, rotation, contrast adjustment, or color transformation of the original PCB image. The abnormal learning dataset may include image data obtained by translation, rotation, contrast, or color transformation of the original PCB image, and manipulation specific regions if the image.

When generating the abnormal learning dataset, the apparatus for determining image normality 100 may also generate ground-truth data. The ground-truth data refers to data indicating a manipulated region. The anomaly detection model 200 may be trained using learning data including the ground-truth data.

The anomaly detection model 200, according to an embodiment of the present disclosure, may be trained to identify abnormal regions by receiving normal and abnormal learning datasets (S310).

The apparatus for determining image normality 100 may evaluate the performance of the trained anomaly detection model 200 (S320). The apparatus for determining image normality 100 may newly generate an abnormal dataset obtained by manipulating the data of the specific region to evaluate the performance of the trained anomaly detection model 200.

There is no limitation on a method of evaluating the performance of the model, and various methods may be used to evaluate the performance of the model. The prediction accuracy of the model may be measured using evaluation indicators, such as accuracy, recall, and F1 score, and the classification performance of the model may also be evaluated using the ROC curve and the AUC. In addition, the performance of the model may be comprehensively evaluated by analyzing the distribution of inference results and the error type through a confusion matrix.

When the evaluation performance of the trained model is satisfactory, the apparatus for determining image normality 100 may identify abnormal regions on a PCB image using the trained model.

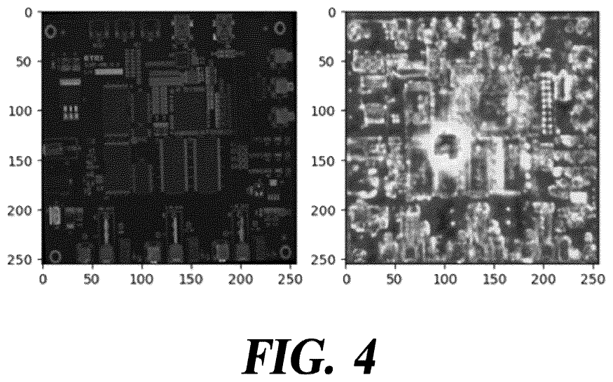

FIG. 4 is an exemplary diagram illustrating an inference result with an abnormal region according to an embodiment of the present disclosure.

The apparatus for determining image normality 100 obtains an inference result identifying abnormal regions using the trained anomaly detection model 200. In the present disclosure, the inference refers to identifying abnormal regions using the trained anomaly detection model 200, and the inference result corresponds to the detection outcome on a PCB image. The inference result may be output in the form of an image or data. In particular, the apparatus for determining image normality 100 may output the inference result in the form of a heat map image. When the inference is performed on a PCB image that includes an abnormal region, differences from the learned data appear in the inference result. As shown in FIG. 4, a color difference appears in the heatmap image due to the presence of the abnormal region.

The heatmap image may clearly visualize the numerical differences between normal and abnormal regions, making it easier to identify abnormal regions. The abnormal region may be intuitively confirmed by visual inspection and may also be programmatically identified.

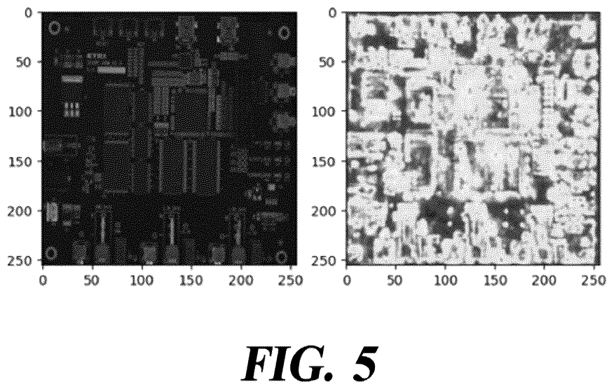

FIG. 5 is an exemplary diagram illustrating an inference result without an abnormal region according to an embodiment of the present disclosure.

Artificial intelligence models use normalization to accurately analyze and predict data. Normalization is the process of standardizing the range and distribution of data, typically by adjusting pixel values based on a mean and standard deviation. This helps the model learn more consistently. However, normalization may also amplify minor differences or distort original features, which can cause a normal image to be incorrectly recognized as abnormal.

When the inference process is applied to a PCB image that does not include any abnormal region, no region exhibiting a clear difference is shown in the result. As shown in FIG. 5, no distinct color difference appears in the heatmap image. In other words, it can be observed that normalization may lead to incorrect recognition of a normal image as abnormal.

In order to solve the problem of recognizing a normal image as abnormal due to normalization, the present disclosure provides a method of analyzing a data value of the heatmap image and determining image normality.

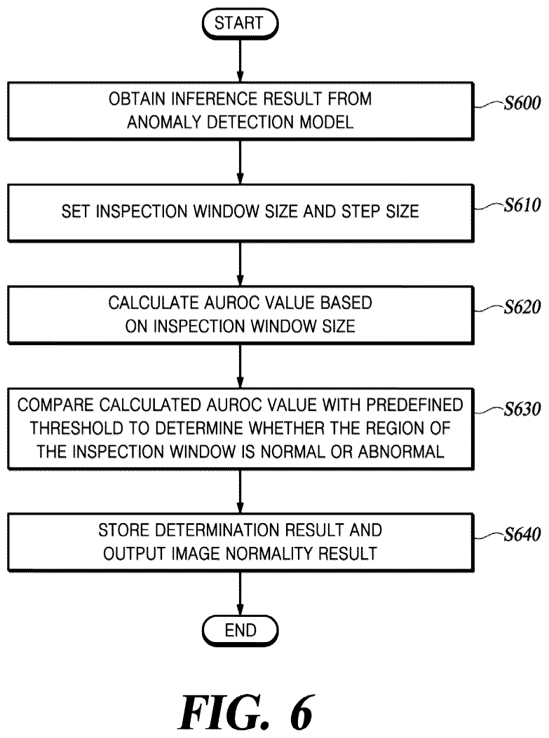

FIG. 6 is a flowchart illustrating a process of determining image normality according to an embodiment of the present disclosure.

The apparatus for determining image normality 100 obtains an inference result using the trained anomaly detection model 200 to identify abnormal regions (S600). In the present disclosure, inference refers to identifying abnormal regions using the trained anomaly detection model 200. The inference result indicates the detected abnormal regions in a PCB image. The inference result may be output in the form of an image or data. In particular, the apparatus for determining image normality 100 may output the inference result as a heat map image.

The apparatus for determining image normality 100 may set the size of an inspection window and the step size (S610).

The inspection window is a small window used to select a specific region from a heatmap image to calculate an AUROC value. The inspection window may be set to perform fine-grained image normality analysis. The size of the inspection window may be adjusted to include a specific portion of the image to be analyzed. For example, a smaller window may detect minute differences, and a larger window may more easily detect broader differences.

The step size is the number of pixels by which the inspection window moves. During image analysis, the apparatus for determining image normality 100 slides the inspection window across the image in increments defined by the step size. A smaller step size allows for more detailed inspection across more regions but increases computational time. In contrast, a larger step size reduces computation time but may skip certain regions during the inspection process.

The size of the inspection window and the step size may be set differently depending on the characteristics of an image and the purpose of analysis.

For example, a smaller window may be used to detect minute abnormal regions, while a larger window may be used to detect broader abnormal regions. A smaller step size may be used for the inspection of the entire image, while a larger step size may be used to prioritize computational efficiency. In a case where all regions are inspected without omission, the step size may be set to 1.

The apparatus for determining image normality 100 may extract data values from the heatmap image based on the inspection window size and calculate an AUROC value (S620).

In some embodiments, the AUROC value may be calculated with reference to the size of the inspection window.

The AUROC is a performance metric for binary classification models. The AUROC value ranges from 0 to 1, where values closer to 1 indicated excellent classification performance and 0.5 indicates random guessing. The AUROC is computed as the area under the ROC curve, which plots the true positive rate against the false positive rate at various threshold values.

In the present disclosure, the AUROC value is used to determine normality of a PCB image. The apparatus for determining image normality 100 sets a fixed-size inspection window on the heatmap image generated by the trained anomaly detection model 200, slides the inspection window incrementally, and calculates the AUROC value for each region of the inspection window.

The apparatus for determining image normality 100 may determine whether the region of the inspection window is normal or abnormal by comparing the calculated AUROC value with a predefined threshold (S630).

In the present disclosure, a sliding AUROC method is used to determine normality of the PCB image. The sliding AUROC method involves setting a region of an image as an inspection window, moving the inspection window incrementally, and calculating an AUROC value for each region.

The apparatus for determining image normality 100 may calculate the AUROC value using the heat map values within the inspection window each time the inspection window moves. The apparatus for determining image normality 100 distinguishes between normal and abnormal images according to a predefined threshold. The calculated AUROC value serves as a criterion for determining whether the corresponding region is normal or abnormal. When the AUROC value is greater than the predefined threshold, the apparatus for determining image normality 100 determines that the region of the inspection window is abnormal. When the AUROC value is less than or equal to the predefined threshold, the apparatus for determining image normality 100 determines that the region of the inspection window is normal.

The apparatus for determining image normality 100 may store the determination result and output whether the image is normal (S640).

The apparatus for determining image normality 100 may calculate the AUROC value for all regions of the heat map image, compare the AUROC value with the predefined threshold, and store regions determined to be abnormal. The apparatus for determining image normality 100 may store the AUROC value and the location information of the inspection window of the abnormal region.

The apparatus for determining image normality 100 may comprehensively determine whether any abnormal region exists in the entire image. If there is even one abnormal region, the PCB image is classified as abnormal. If it is determined that all regions are normal, the PCB image is classified as normal. The apparatus for determining image normality 100 finally outputs the result of determining whether the image is normal or abnormal.

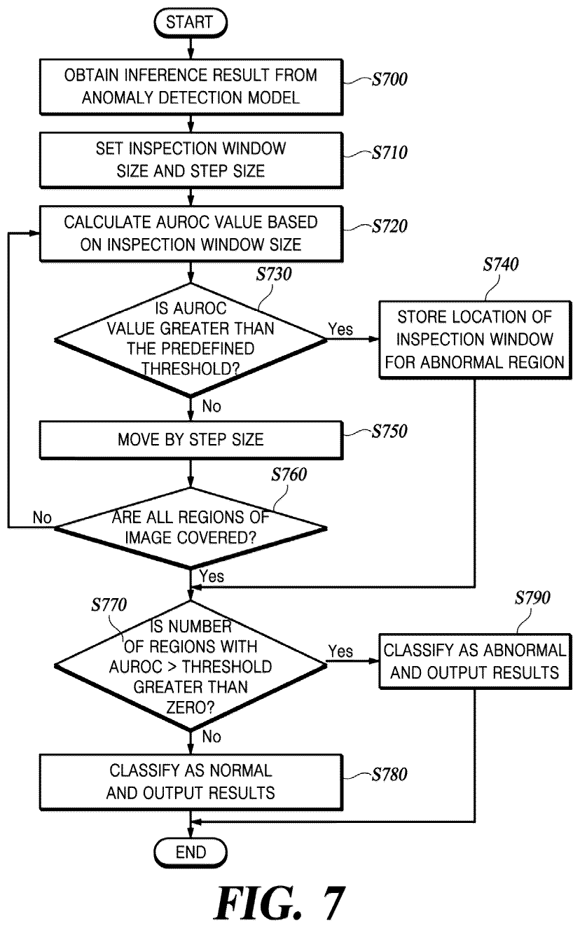

FIG. 7 is a flowchart illustrating a process of determining an abnormal region using a sliding AUROC according to an embodiment of the present disclosure.

The apparatus for determining image normality 100 obtains an inference result from the trained anomaly detection model 200 (S700).

The apparatus for determining image normality 100 may set the size of the inspection window and the step size (S710).

The apparatus for determining image normality 100 may extract data values from the heatmap image based on the size of the inspection window and calculate the AUROC value (S720).

The apparatus for determining image normality 100 may determine whether the region of the inspection window is normal or abnormal by comparing the calculated AUROC value with a predefined threshold (S730).

When the AUROC value is greater than the predefined threshold, the apparatus for determining image normality 100 determines that the region of the inspection window is abnormal. The apparatus for determining image normality 100 may calculate the AUROC value, compare the AUROC value with the predefined threshold, and store information about regions determined to be abnormal (S740). For example, the apparatus for determining image normality 100 may store both the AUROC value and the location of the inspection window for the abnormal region.

When the AUROC value is less than or equal to the predefined threshold, the apparatus for determining image normality 100 determines that the region of the inspection window is normal. Upon this determination, the apparatus for determining image normality 100 may move the inspection window by the step size (S750).

The apparatus for determining image normality 100 may determine image normality for all regions of the heatmap image by sliding the inspection window in increments of the step size (S760). The apparatus for determining image normality 100 moves the inspection window by the step size and repeats the process of determining image normality. The apparatus for determining image normality 100 may move the inspection window along the x-axis and calculate the AUROC value at each location. Upon reaching the end of the x-axis, the apparatus for determining image normality 100 may move down by the step size in the y-axis direction, move again along the x-axis, and repeat the process of determining image normality. The apparatus for determining image normality 100 may continue the process of moving the inspection window and the process of determining image normality until all regions of the image are covered.

The apparatus for determining image normality 100 may determine whether any region has an AUROC value greater than the predefined threshold (S770). For example, the apparatus for determining image normality 100 may determine whether the number of regions with AUROC values exceeding the predefined threshold is greater than zero.

When no region exceeds the predefined threshold, the apparatus for determining image normality 100 may determine that the PCB image is normal (S780). The apparatus for determining image normality 100 may output the final result of determining image normality.

When at least one region exceeds the predefined threshold, the apparatus for determining image normality 100 may determine that the PCB image is abnormal (S790). The apparatus for determining image normality 100 may output the final result of determining image normality. The apparatus for determining image normality 100 may output the result of determining image normality using the AUROC value and the location of the inspection window for the stored abnormal region. The output determination result may include the location of the inspection window for the stored abnormal region.

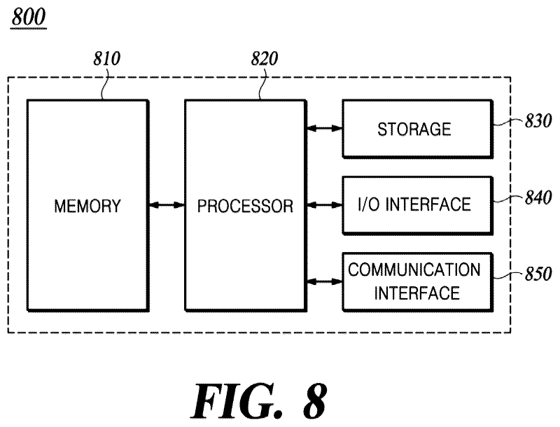

FIG. 8 is a block diagram illustrating an exemplary computing device that may be used for implementing a method or an apparatus according to the present disclosure.

The computing device 800 may include all or part of a memory 810, a processor 820, a storage 830, an input/output interface 840, and a communication interface 850. The computing device 800 may be a stationary computing device, such as a desktop computer or a server, or a mobile computing device, such as a laptop computer or a smartphone. The computing device 800 may include a specialized hardware accelerator capable of processing operations of an artificial intelligence model in an efficient manner. For example, the computing device 800 may include a graphic processing unit (GPU), a tensor processing unit (TPU), or a neural processing unit (NPU).

The memory 810 may store a program that enables the processor 820 to perform methods or operations according to various embodiments of the present disclosure. For example, a program may include a plurality of instructions executable by the processor 820, and the methods or operations described above may be performed by executing the plurality of instructions by the processor 820. The memory 810 may consist of a single memory or a plurality of memories. In this case, information required to perform the methods or operation according to various embodiments of the present disclosure may be stored in a single memory or distributed across a plurality of memories. When the memory 810 is composed of a plurality of memories, the plurality of memories may be physically separated. The memory 810 may include at least one of volatile memory and non-volatile memory. Volatile memory includes Static Random Access Memory (SRAM) or Dynamic Random Access Memory (DRAM), while non-volatile memory includes flash memory.

The processor 820 may include at least one core capable of executing at least one instruction. The processor 820 may execute instructions stored in the memory 810. The processor 820 may consist of a single processor or a plurality of processors.

The storage 830 maintains stored data even if power supplied to the computing device 800 is cut off. For example, the storage 830 may include non-volatile memory or may include a storage medium such as a magnetic tape, an optical disk, or a magnetic disk. A program stored in the storage 830 may be loaded into the memory 810 before being executed by the processor 820. The storage 830 may store files written in a program language, and a program created from the files by a compiler may be loaded into the memory 810. The storage 830 may store data to be processed by the processor 820 and/or data processed by the processor 820.

The input/output interface 840 may provide an interface with an input device such as a keyboard or a mouse and/or an output device such as a display device or a printer. The user may trigger execution of a program by the processor 820 through the input device and/or check the processing results of the processor 820 through the output device.

The communication interface 850 may provide access to an external network. The computing device 800 may communicate with other devices through the communication interface 850.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A method for determining image normality using an anomaly detection model, the method comprising:
obtaining an inference result of the anomaly detection model;
determining a step size and a size of an inspection window for identifying abnormal regions;
calculating an AUROC value based on the inspection window;
determining whether a region of the inspection window is normal or abnormal by comparing the AUROC value with a predefined threshold; and
determining whether an image is normal or abnormal based on the result of identifying abnormal regions.

2. The method of claim 1, wherein the inference result of the anomaly detection model is a heatmap image.

3. The method of claim 1, wherein the determining the step size and the size of the inspection window for identifying abnormal regions comprises:
determining the step size and the size of the inspection window based on characteristics of an image and a purpose of analysis.

4. The method of claim 1, wherein the calculating an AUROC value based on the size of the inspection window comprises:
moving the inspection window by the step size and calculating the AUROC value within a region of the inspection window.

5. The method of claim 1, wherein the determining of whether the region of the inspection window is normal or abnormal by comparing the AUROC value with the predefined threshold comprises:
determining that the region of the inspection window is abnormal when the AUROC value is greater than the predefined threshold.

6. The method of claim 1, wherein the determining of whether the region of the inspection window is normal or abnormal by comparing the AUROC value with the predefined threshold comprises:
determining that the region of the inspection window is normal when the AUROC value is less than or equal to the predefined threshold.

7. The method of claim 1, wherein the determining of whether the image is normal based on the result of determining the abnormal region comprises:
determining that the image is normal when no region has an AUROC value greater than the predefined threshold.

8. The method of claim 1, wherein the determining of whether the image is normal based on the result of determining the abnormal region comprises:
determining that the image is abnormal when a region has an AUROC value greater than the predefined threshold.

9. The method of claim 1, further comprising outputting a result of determining whether the image is normal.

10. An apparatus for determining image normality using an anomaly detection model, the apparatus comprising:
at least one memory storing instructions; and
at least one processor,
wherein, by executing the instructions, the at least one processor is configured to:
obtain an inference result of the anomaly detection model;
determine a step size and a size of an inspection window for identifying abnormal regions;
calculate an AUROC value based on the inspection window;
determine whether a region of the inspection window is normal or abnormal by comparing the AUROC value with a predefined threshold; and
determine whether an image is normal or abnormal based on the result of identifying abnormal regions.

11. The apparatus of claim 10, wherein the inference result of the anomaly detection model is a heatmap image.

12. The apparatus of claim 10, wherein the determining of the step size and the size of the inspection window for identifying abnormal regions comprises:
determining the step size and the size of the inspection window based on characteristics of an image and a purpose of analysis.

13. The apparatus of claim 10, wherein the calculating of the AUROC value based on the size of the inspection window comprises:
moving the inspection window by the step size and calculating the AUROC value within a region of the inspection window.

14. The apparatus of claim 10, wherein the determining of whether the region of the inspection window is normal or abnormal by comparing the AUROC value with the predefined threshold comprises:
determining that the region of the inspection window is abnormal when the AUROC value is greater than the predefined threshold.

15. The apparatus of claim 10, wherein the determining of whether the region of the inspection window is normal or abnormal by comparing the AUROC value with the predefined threshold comprises:
determining that the region of the inspection window is normal when the AUROC value is less than or equal to the predefined threshold.

16. The apparatus of claim 10, wherein the determining of whether the image is normal based on the result of determining the abnormal region comprises:
determining that the image is normal when no region has an AUROC value greater than the predefined threshold.

17. The apparatus of claim 10, wherein the determining of whether the image is normal based on the result of determining the abnormal region comprises:
determining that the image is abnormal when a region has an AUROC value greater than the predefined threshold.

18. The apparatus of claim 10, further comprising outputting a result of determining whether the image is normal.
